(19) United States
(12) Patent Application Publication
(10) Pub. No.: US 2025/0330604 A1
(43) Pub. Date: Oct. 23, 2025

(54) CONSISTENT RESAMPLING FACTORS AND ADAPTIVE RESAMPLING FACTORS FOR FEATURES IN GENERATIVE FACE VIDEO COMPRESSION

(71) Applicant: Alibaba (China) Co., Ltd., Hangzhou (CN)

(72) Inventors: Renjie Zou, Beijing (CN); Bolin Chen, Hong Kong (CN); Ru-Ling Liao, Sunnyvale, CA (US); Jie Chen, Beijing (CN); Yan Ye, Sunnyvale, CA (US)

(21) Appl. No.: 19/096,648

(22) Filed: Mar. 31, 2025

Related U.S. Application Data
(60) Provisional application No. 63/631,895, filed on Apr. 9, 2024.

(51) Int. Cl. H04N 19/132; G06V 10/77; G06V 10/82; G06V 20/40; G06V 40/16; H04N 19/172; H04N 19/192

(52) U.S. Cl. CPC H04N 19/132; G06V 10/7715; G06V 10/82; G06V 40/168; H04N 19/172; H04N 19/192; G06V 20/46

(57) ABSTRACT

Generative Face Video Compression (“GFVC”) techniques are provided to improve performance of facial video compression. A computing system is configured to perform GFVC upon heterogeneous-resolution sequences based on consistent resampling factors and based on adaptive resampling factors. Adaptive resampling factors are further implemented by: interpolation of heterogeneous-resolution sequences in GFVC to simplify resolution unification; multi-scale architecture of feature extractors in GFVC to capture details across heterogeneous resolutions by integrating multiple processing layers; and adapting dynamic neural networks in real-time to process varying input resolutions of heterogeneous-resolution sequences in GFVC efficiently.

### PRIORITY

This patent application claims priority to U.S. Provisional Patent Application No. 63/631,895, filed on Apr. 9, 2024, entitled “CONSISTENT RESAMPLING FACTORS AND ADAPTIVE RESAMPLING FACTORS FOR FEATURES IN GENERATIVE FACE VIDEO COMPRESSION,” and is fully incorporated by reference herein.

### BACKGROUND

Machine learning tools are being incorporated into intra-frame coding used in video coding standards to achieve further improvements in compression efficiency over prior standards such as H.264/AVC (Advanced Video Coding) and H.265/HEVC (High Efficiency Video Coding), and, most recently, Versatile Video Coding (“VVC”). Furthermore, learning-based coding will most likely be a part of future video coding standards succeeding VVC as well.

Present image coding techniques are primarily based in lossy compression, based on a framework including transform coding, quantization, and entropy coding. For many years, lossy compression has achieved compression ratios which are suited to image capture and image storage at limited scales. However, computer systems are increasingly configured to capture and store images at much larger scales, for applications such as surveillance, streaming, data mining, and computer vision. As a result, it is desired for future image coding standards to achieve even smaller image sizes without greatly sacrificing image quality.

Machine learning has not been a part of past image coding standards, whether in the compression of still images or in intra-frame coding used in video compression. As recently as the VVC standardization process from 2018 to 2020, working groups of the ISO/IEC and ITU-T reviewed, but did not adopt, learning-based coding proposals. The 32nd meeting of the Joint Video Experts Team (“JVET”) in October 2023 convened an ad hoc group on Generative Face Video Compression (“GFVC”), including software implementation, test conditions, coordinated experimentation, and interoperability studies thereof.

There remains a need to further improve facial video compression techniques according to GFVC.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a block diagram of an image compression process in accordance with a variety of image coding techniques.

FIG. 2 illustrates a flowchart of an encoding process and a decoding process according to Generative Face Video Compression (“GFVC”) based on consistent resampling factors according to example embodiments of the present disclosure.

FIG. 3 illustrates a flowchart of an encoding process and a decoding process according to GFVC based on adaptive resampling factors according to example embodiments of the present disclosure.

FIG. 4A and FIG. 4B illustrate a feature extractor according to example embodiments of the present disclosure.

FIG. 5 illustrates a deep generative model of GFVC implemented as a dynamic neural network according to example embodiments of the present disclosure.

FIG. 6 illustrates an example system for implementing the processes and methods described herein for performing GFVC upon heterogeneous-resolution sequences based on consistent resampling factors and based on adaptive resampling factors.

### DETAILED DESCRIPTION

Example embodiments of the present disclosure provide performing Generative Face Video Compression (“GFVC”) upon heterogeneous-resolution sequences based on consistent resampling factors and based on adaptive resampling factors. Adaptive resampling factors are further implemented by: interpolation of heterogeneous-resolution sequences in GFVC to simplify resolution unification; multi-scale architecture of feature extractors in GFVC to capture details across heterogeneous resolutions by integrating multiple processing layers; and adapting dynamic neural networks in real-time to process varying input resolutions of heterogeneous-resolution sequences in GFVC efficiently.

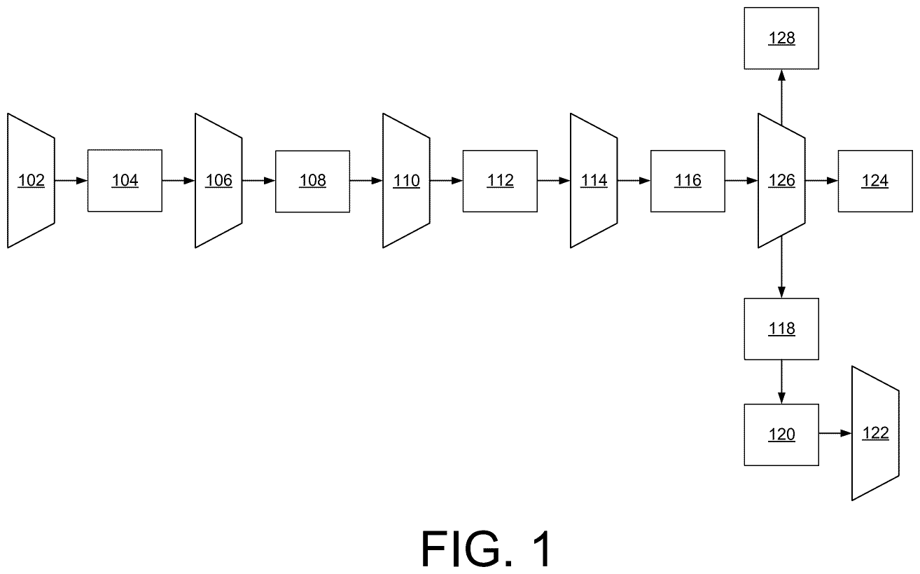

FIG. 1 illustrates a block diagram of an image compression process 100 in accordance with a variety of image coding techniques, such as those implemented by a variety of intra-frame coding techniques, such as those implemented by H.264/AVC (Advanced Video Coding), H.265/HEVC (High Efficiency Video Coding), and Versatile Video Coding (“VVC”). The image compression process 100 can include lossless steps and lossy steps.

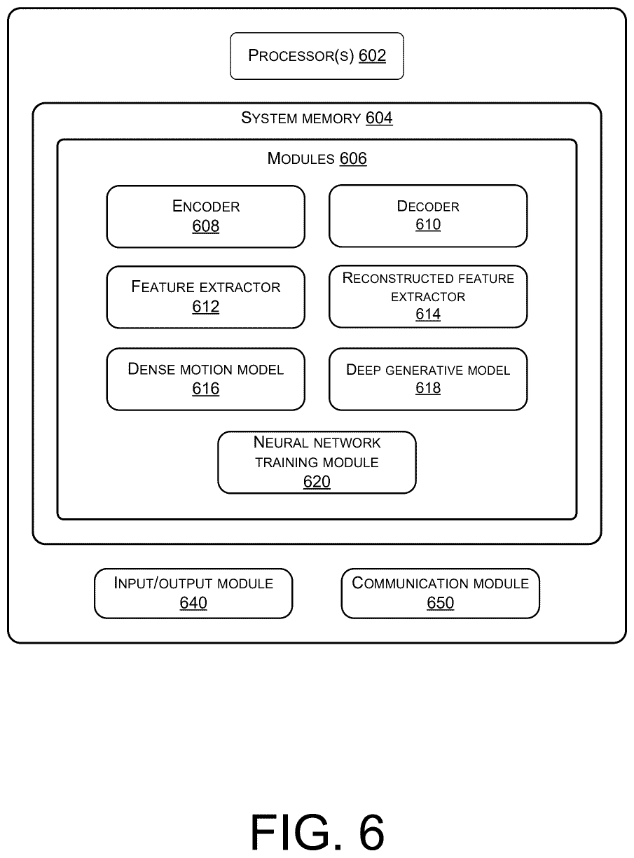

In accordance with AVC, HEVC, and VVC, a block-based hybrid video coding framework is implemented to exploit the spatial redundancy, temporal redundancy and information entropy redundancy in video. A computing system includes at least one or more processors and a computer-readable storage medium communicatively coupled to the one or more processors. The computer-readable storage medium is a non-transient or non-transitory computer-readable storage medium, as defined subsequently with reference to FIG. 6, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by the above-mentioned standards, and operations of a decoder as described by the above-mentioned standards. Some of these encoder operations and decoder operations according to the above-mentioned standard are subsequently described in further detail, though these subsequent descriptions should not be understood as exhaustive of encoder operations and decoder operations according to the above-mentioned standards. Subsequently, a “block-based encoder” and a “block-based decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a block-based encoder and a block-based decoder further include computer-readable instructions stored on a computer-readable storage medium which are executable by one or more processors of a computing system to configure the one or more processors to perform operations not specified by the above-mentioned standards. A block-based encoder should not be understood as limited to operations of a reference implementation of an encoder, but including further computer-readable instructions configuring one or more processors of a computing system to perform further operations as described herein. A block-based decoder should not be understood as limited to operations of a reference implementation of a decoder, but including further computer-readable instructions configuring one or more processors of a computing system to perform further operations as described herein.

It should be understood that the image compression process 100, while conforming to each of the above-mentioned standards (and to other image coding standards or techniques based on image compression, without limitation thereto), does not describe the entirety of each of the above-mentioned standards (or the entirety of other image coding standards or techniques). Furthermore, the elements of the image compression process 100 can be implemented differently according to each of the above-mentioned standards (and according to other image coding standards or techniques), without limitation.

According to an image compression process 100, a computing system is configured by one or more sets of computer-executable instructions to perform several operations upon an input picture 102. First, a computing system performs a transform operation 104 upon the input picture 102. Herein, one or more processors of the computing system transform picture data from a spatial domain representation (i.e., picture pixel data) into a frequency domain representation by a Fourier transform computation such as discrete cosine transform (“DCT”). In a frequency domain representation, the transformed picture data is represented by transform coefficients 106.

According to an image compression process 100, the computing system then performs a quantization operation 108 upon the transform coefficients 106. Herein, one or more processors of the computing system generate a quantization index 110, which stores a limited subset of the color information stored in picture data.

A computing system then performs an entropy encoding operation 112 upon the quantization index 110. Herein, one or more processors of the computing system perform a coding operation, such as arithmetic coding, wherein symbols are coded as sequences of bits depending on their probability of occurrence. The entropy encoding operation 112 yields a compressed picture 114.

One or more processors of a computing system are further configured by one or more sets of computer-executable instructions to perform several operations upon the compressed picture 114 to output the compressed picture.

For example, according to some image coding standards, a computing system performs an entropy decoding operation 116, a dequantization operation 118, and an inverse transform operation 120 upon the compressed picture 114 to output a reconstructed picture 122. By way of example, where a transform operation 104 is a DCT computation, the inverse transform operation 120 can be an inverse discrete cosine transform (“IDCT”) computation which returns a frequency domain representation of picture data to a spatial domain representation.

However, a decoded picture need not undergo an inverse transform operation 120 to be used in other computations. One or more processors of a computing system can be configured to output the compressed picture 114 in formats other than a reconstructed picture. Prior to performing an inverse transform operation 120, or instead of performing an inverse transform operation 120, one or more processors of the computing system can be configured to perform an image processing operation 124 upon a decoded picture 126 yielded by the entropy decoding operation 116.

By way of example, one or more processors of the computing system can resize a decoded picture, rotate a decoded picture, reshape a decoded picture, crop a decoded picture, rescale a decoded picture in any or all color channels thereof, shift a decoded picture by some number of pixels in any direction, alter a decoded picture in brightness or contrast, flip a decoded picture in any orientation, inject noise into a decoded picture, reweigh frequency channels of a decoded picture, apply frequency jitter to a decoded picture, and the like.

Prior to performing an inverse transform operation 120, or instead of performing an inverse transform operation 120, one or more processors of the computing system can be configured to input a decoded picture 126 into a learning model 128. One or more processors of a computing system can input the decoded picture 126 into any layer of a learning model 128, which further configures the one or more processors to perform training or inference computations based on the decoded picture 126.

A computing system can perform any, some, or all of outputting a reconstructed picture 122; performing an image processing operation 124 upon a decoded picture 126; and inputting a decoded picture 126 into a learning model 128, without limitation.

Given an image compression process 100 in accordance with a variety of image coding techniques as described above, learning-based coding can be incorporated into the image compression process 100. Learned image compression (“LIC”) architectures generally fall into two categories: hybrid coding, and end-to-end learning-based coding.

End-to-end learning-based coding generally refers to modifying one or more of the steps of the overall image compression process 100 such that parameters learned by one or more learning models. Separate from the image compression process 100, on another computing system, datasets can be input into learning models to train the learning models to learn parameters to improve the computation and output of results required for the performance of various computational tasks.

By way of example, LIC is implemented by a Variational Auto-Encoder architecture (“VAE”), which further includes an encoder f₁₀₀ (x), a decoder g_{θ}(z), and a quantizer q(y). x is an input image, y=f₁₀₀ (x) is a latent representation, z=q(y) is a quantized and encoded bitstream (e.g., through lossless arithmetic coding) for storage and transmission. Since the deterministic quantization is non-differentiable with regard to network parameters φ and θ, the additive uniform noise is generally used to optimize an approximated differentiable rate distortion (“RD”) loss, as described in Equation 1 below:

$${min}_{φ , θ} {E}_{p ( x ) {p}_{φ} ( Z \vert 𝒳 )} [ λ D ( x , {g}_{θ} ( z ) ) + R ( z ) ]$$

where p(x) is the probability density function of all natural images, D(x, g_{θ}(z)) is a distortion loss (e.g., mean-square error (“MSE”) or mean absolute error (“MAE”)) between the original input and the reconstruction, R(z) is a rate loss estimating the bitrate of the encoded bitstream, and λ is a hyperparameter that controls the optimization of the network parameters to trade off reconstruction quality against compression bitrate. In general, for each target value of λ, a set of model parameters φ and θ needs to be trained for the corresponding optimization of Equation 1.

A learning model can include one or more sets of computer-readable instructions executable by one or more processors of a computing system to perform tasks that include processing input and various parameters of the model, and outputting results. A learning model can be, for example, a layered model such as a deep neural network, which can have a fully-connected structure, can have a feedforward structure such as a convolutional neural network (“CNN”), can have a backpropagation structure such as a recurrent neural network (“RNN”), or can have other architectures suited to the computation of particular tasks. Generally, any layered model having multiple layers between an input layer and output layer is a deep neural network (“DNN”).

Tasks can include, for example, classification, clustering, matching, regression, semantic segmentation, and the like. Tasks can provide output for the performance of functions supporting computer vision or machine vision functions, such as recognizing objects and/or boundaries in images and/or video; tracking movement of objects in video in real-time; matching recognized objects in images and/or video to other images and/or video; providing annotations or transcriptions of images, video, and/or audio in real-time; and the like.

Deep generative models, including VAE and Generative Adversarial Networks (“GAN”), have been applied to improve performance of facial video compression. The X2Face model is trained to control face generation via images, audio, and pose codes. Few-shot adversarial learning is a technique to train realistic neural talking head models.

“fs-vid2vid” or “FV2V” implements 3D keypoint representation driving a generative model for rendering the target frame. First Order Motion Model (“FOMM”) implements a mobile-compatible video chat system. The VSBNet model is trained utilizing adversarial learning to reconstruct origin frames from the landmarks. In addition, Compact feature learning (“CFTE”) implements an end-to-end talking-head video compression framework for talking face video compression under ultra-low bandwidth. CFTE leverages the compact feature representation to compensate for the temporal evolution and reconstruct the target facial video frame in an end-to-end manner, and can be incorporated into the video coding framework with the supervision of rate-distortion objective. In addition, the 3D morphable model (“3DMM”) template implements facial semantics to characterize facial video and implement face manipulation for facial video coding.

Table 1 below further summarizes facial representations for generative face video compression algorithms. In particular, the face images exhibit strong statistical regularities, which can be economically characterized with 2D landmarks, 2D keypoints, region matrix, 3D keypoints, compact feature matrix and facial semantics. Such facial description strategies can lead to reduced coding bit-rate and improve the coding efficiency, thus being applicable to video conferencing and live entertainment.

| Facial | |
|---|---|
| representation | Interpretation |
| 2D landmarks | VSBNet is a representative model which can |
| | utilize 98 groups of 2D facial landmarks [symbol] ^{2×98} |
| | to depict the key structure information of |
| | human face, where the total number of encoding |
| | parameters for each inter frame is 196. |
| 2D keypoints | FOMM is a representative model which |
| and affine | adopts 10 groups of learned 2D keypoints |
| transformation | [symbol] ^{2×10} along with their local affine |
| matrix | transformations [symbol] ^{2×2×10} to characterize complex |
| | motions. The total number of encoding |
| | parameters for each inter frame is 60. |
| Region matrix | MRAA is a representative model which |
| | extracts consistent regions of talking face to |
| | describe locations, shape, and pose, mainly |
| | represented with shift matrix [symbol] ^{2×10}, covar |
| | matrix [symbol] ^{2×2×10} and affine matrix [symbol] ^{2×2×10}. |
| | As such, the total number of encoding |
| | parameters for each inter frame is 100. |
| 3D keypoints | Face_vid2vid is a representative model which |
| | can estimate 12-dimension head parameters |
| | (i.e., rotation matrix [symbol] ^{3×3} and translation |
| | parameters [symbol] ^{3×1} ) and 15 groups of learned 3D |
| | keypoint perturbations [symbol] ^{3×15} due to facial |
| | expressions, where the total number of encoding |
| | parameters for each inter frame is 57. |
| Compact | CFTE is a representative model which can |
| feature | model the temporal evolution of faces into |
| matrix | learned compact feature representation with the |
| | matrix [symbol] ^{4×4}, where the total number of |
| | encoding parameters for each inter frame is 16. |
| Facial | Interactive Face Video Coding (“IFVC”) is a |
| semantics | representative model which adopts a collection |
| | of transmitted facial semantics to represent the |
| | face frame, including mouth parameters [symbol] ⁶, |
| | eye parameter [symbol] ¹, rotation parameters [symbol] ³, |
| | translation parameters [symbol] ³ and location parameter |
| | [symbol] ¹. Totally, the number of encoding |
| | parameters for each inter frame is 14. |

The 32nd meeting of the Joint Video Experts Team (“JVET”) in October 2023 convened an ad hoc group on Generative Face Video Compression (“GFVC”), including software implementation, test conditions, coordinated experimentation, and interoperability studies thereof. A unified software package, accommodating different GFVC methods through various face video representations and enabling coding with the VVC Main 10 profile, was proposed. The results showed that GFVC could achieve significantly better reconstruction quality than the existing VVC standard at ultra-low bitrate ranges.

However, this software package only supports coding video sequences with a resolution of 256×256. This limitation poses a significant challenge in catering to the growing demand for higher resolution content, driven by the proliferation of high-definition displays and the increasing expectation for more detailed and immersive visual experiences.

Therefore, example embodiments of the present disclosure enhance GFVC by enabling effective processing of heterogeneous-resolution video sequences, based on consistent resampling factors and based on adaptive resampling factors. Adaptive resampling factors are further implemented by: interpolation of heterogeneous-resolution sequences in GFVC to simplify resolution unification, multi-scale architecture of feature extractors in GFVC to capture details across heterogeneous resolutions by integrating multiple processing layers, and adapting dynamic neural networks in real-time to process varying input resolutions of heterogeneous-resolution sequences in GFVC efficiently. Such solutions enable GFVC transcoding of video sequences across a wider array of resolutions, ranging from the current standard of 256×256 to the more demanding and detail-rich formats of 512×512, 1024×1024, 1920×1024 and even higher resolutions. Furthermore, such solutions adaptively and scalably accommodate future increases in resolution without requiring substantial redesign or overhaul of the underlying coding framework.

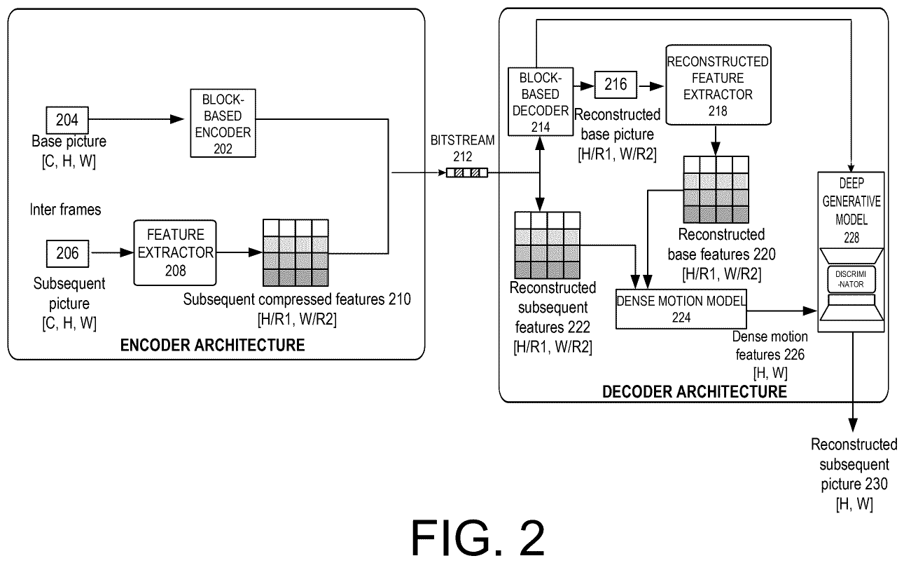

FIG. 2 illustrates a flowchart of an encoding process and a decoding process according to GFVC based on consistent resampling factors according to example embodiments of the present disclosure.

In an encoding process, a block-based encoder 202 configures one or more processors of a computing system to perform several operations upon a base picture 204 of a sequence (i.e., the key frame) from an image source. By way of example, as described above with reference to FIG. 1, a transform operation 104, a quantization operation 108, and an entropy encoding operation 112 can be performed upon the base picture to output a compressed base picture.

The base picture 204 has a dimensionality denoted by [C, H, W], where C represents the number of channels (e.g., color depth), H stands for the height, and W signifies the width of the frame. Picture sequences can be heterogeneous in resolution: pictures of a same sequence have same H and W values, while different sequences can include respective pictures having different H and W values.

Additionally, for each subsequent picture 206 of the sequence (i.e., inter frames), GFVC provides a feature extractor 208 which configures one or more processors of a computing system to extract compact human features of each subsequent picture 206 (“subsequent features 210”), and to compress the inter-predicted residuals of the subsequent features. The subsequent features 210, each also having dimensionality of [C, H, W], are scaled based on resampling factors R1 and R2 to a rescaled resolution of [H/R1, W/R2]. With reference to FIG. 2, R1 and R2 are constant regardless of resolution of a sequence, thus achieving uniformity in feature scaling and extraction.

A feature extractor 208 should be understood as a learning model trained to extract compact human features from picture data input into the learning model. As described above with reference to Table 1, compact human features can be, but is not limited to, learned keypoints extracted by a source keypoint extractor and a driving keypoint extractor of a FOMM; a compact feature matrix extracted by a CFTE feature extractor; facial semantics extracted according to IFVC; and the like.

The compressed base picture and the compressed subsequent features 210 are transmitted in a bitstream 212.

In a decoding process, a block-based decoder 214 configures one or more processors of a computing system to perform several operations upon a compressed base picture transmitted in a bitstream 212, including an entropy decoding operation 116 and motion compensation to output a reconstructed base picture 216. GFVC further provides a reconstructed feature extractor 218 which configures one or more processors of a computing system to extract compact human features of the reconstructed base picture 216 (“reconstructed base features 220”). The reconstructed base features 220 are also scaled based on the resampling factors R1 and R2 to a rescaled resolution of [H/R1, W/R2].

The block-based decoder 214 also configures one or more processors of a computing system to perform an entropy decoding operation 116 and motion compensation upon the compressed subsequent features 210 transmitted in the bitstream to output reconstructed subsequent features 222 having resolution [H/R1, W/R2].

GFVC further provides a dense motion model 224 which configures one or more processors of a computing system to compute, based on the reconstructed base features 220 and the reconstructed subsequent features 222, a relevant sparse motion field and yield a pixel-wise dense motion map containing dense motion features 226 having the original resolution of [H, W].

Thus, sequences of heterogeneous resolutions—such as, by way of example, when R1=R2=64, 256×256, 512×512, 1024×1024, and 1920×1024—are rescaled to correspondingly smaller feature resolutions of 4×4, 8×8, 16×16, and 30×16. Conversely, during decoding, motion information at these scaled-down resolutions (4×4, 8×8, 16×16, 30×16) is expanded to generate dense motion features at their original, full resolutions (256×256, 512×512, 1024×1024, and 1920×1024).

GFVC further provides a deep generative model 228 which configures one or more processors of a computing system to reconstruct, based on the reconstructed base picture 216 and dense motion features 226, a reconstructed subsequent picture 230 having dimensionality [C, H, W].

The method described with reference to FIG. 2, wherein encoding and decoding are performed according to GFVC based on consistent resampling factors, benefits from characteristics of convolutional neural networks. The convolutional layers' spatial abstraction and encoding visual features enables heterogeneous-resolution sequences to be coded in a structured and scalable manner.

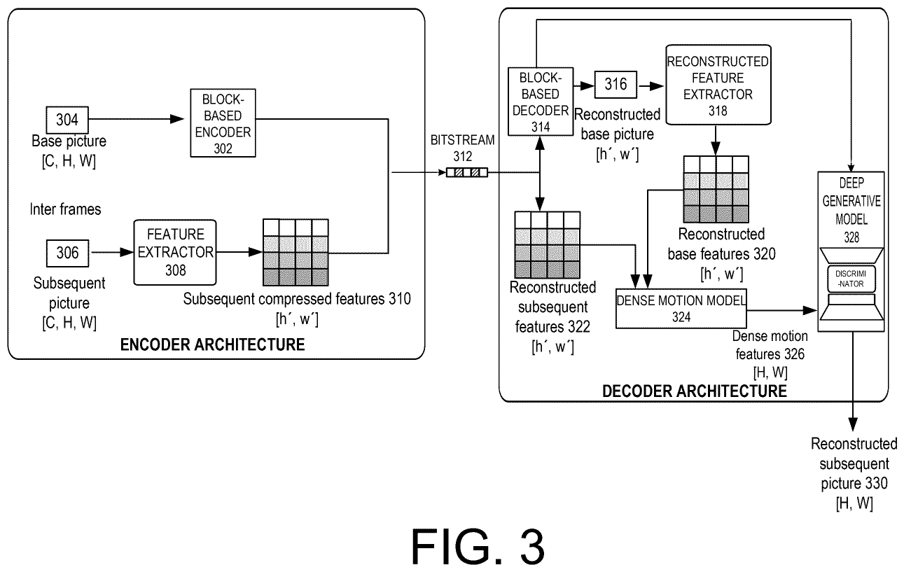

FIG. 3 illustrates a flowchart of an encoding process and a decoding process according to GFVC based on adaptive resampling factors according to example embodiments of the present disclosure.

As illustrated in FIG. 3, a block-based encoder 302 configures one or more processors of a computing system to perform several operations upon a base picture 304 of a sequence to output a compressed base picture. The base picture 304 has a dimensionality denoted by [C, H, W].

For each subsequent picture 306 of the sequence, GFVC provides a feature extractor 308 which configures one or more processors of a computing system to extract subsequent features 310, and to compress the inter-predicted residuals of the subsequent features 310. The subsequent features 310 are each resampled to resolution [h′, w′], where h′ and w′ are configured as constant values regardless of resolution of a sequence.

In a decoding process, a block-based decoder 314 configures one or more processors of a computing system to perform several operations upon a compressed base picture transmitted in a bitstream 312 to output a reconstructed base picture 316. GFVC further provides a reconstructed feature extractor 318 which configures one or more processors of a computing system to extract reconstructed base features 320. The reconstructed base features 320 are each resampled to resolution [h′, w′].

The block-based decoder 314 also configures one or more processors of a computing system to perform operations upon the compressed subsequent features 310 transmitted in the bitstream 312 to output reconstructed subsequent features 322 having resolution [h′, w′].

GFVC further provides a dense motion model 324 which configures one or more processors of a computing system to compute, based on the reconstructed base features 320 and the reconstructed subsequent features 322, a relevant sparse motion field and yield a pixel-wise dense motion map containing dense motion features 326 having the original resolution of [H, W].

Thus, the encoding process uniformly downscales sequences of heterogeneous resolutions (such as, by way of example, 256×256, 512×512, 1024×1024, and 1920×1024) to yield features all at the same resolution (by way of example, 4×4). This uniformity in feature size simplifies processing and standardizes the encoding stage regardless of the source resolution. The decoding process upconverts motion information captured at this unified scale (4×4) to reconstruct dense motion features at heterogeneous original resolutions (such as, respectively, 256×256, 512×512, 1024×1024, and 1920×1024).

GFVC further provides a deep generative model 328 which configures one or more processors of a computing system to reconstruct, based on the reconstructed base picture 316 and dense motion features 326, a reconstructed subsequent picture 330 having dimensionality [C, H, W].

In comparison, whereas GFVC based on consistent resampling factors adjusts resolutions relative to the input resolution, GFVC based on adaptive sampling factors standardizes input feature size to a single resolution.

Furthermore, example embodiments of the present disclosure provide interpolation during resampling of features.

As described above, with reference to FIG. 3, the feature extractor 308 and the reconstructed feature extractor 318, respectively, configure one or more processors to resample the subsequent features 310 and the reconstructed base features 320 each to resolution [h′, w′]. To accommodate sequences of multiple resolutions, an interpolation operation is performed during resampling, enabling standardization of diverse resolutions to a uniform resolution.

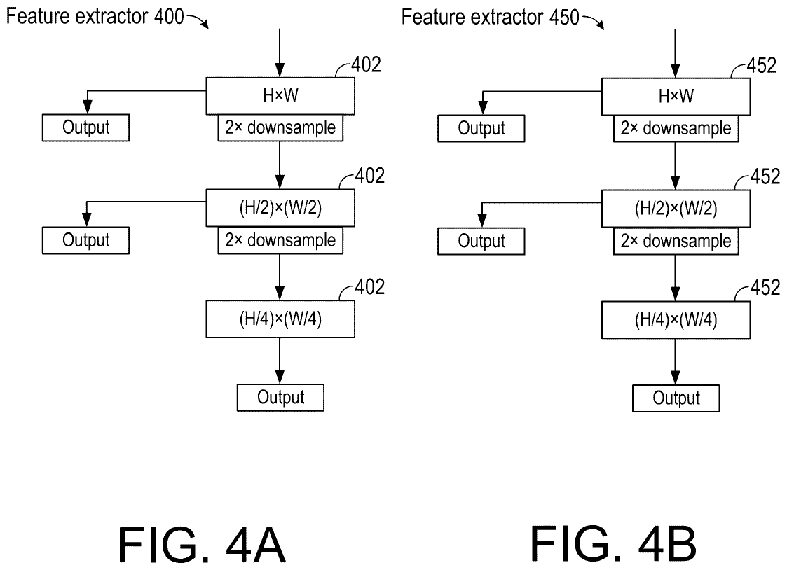

Furthermore, example embodiments of the present disclosure provide multi-scale architecture of feature extractors in GFVC. FIG. 4A and FIG. 4B illustrate a feature extractor according to example embodiments of the present disclosure, each implemented as a layered learning model wherein each down-sampling layer 402 or up-sampling layer 452 configures one or more processors of a computing system to, respectively, down-sample or up-sample input picture data by a factor of 2, then to either output extracted features or to input the resampled picture data into a subsequent layer.

The feature extractor 400 of FIG. 4A down-samples input picture data to resolution [h′, w′], and the feature extractor 450 of FIG. 4B up-samples input picture data to resolution [h′, w′]. Heterogeneous-resolution picture data can be input, and can be output after processing by a different number of layers: smaller-resolution picture data is processed by fewer layers of the feature extractor 400 of FIG. 4A to reach resolution [h′, w′], and larger-resolution picture data is processed by more layers of the feature extractor 400 of FIG. 4A. Smaller-resolution picture data is processed by more layers of the feature extractor 450 of FIG. 4B to reach resolution [h′, w′], and larger-resolution picture data is processed by fewer layers of the feature extractor 450 of FIG. 4B.

Thus, the feature extractors of FIGS. 4A and 4B configure one or more processors of a computing system to process heterogeneous-resolution sequences without further post-extraction resampling, improving computational efficiency.

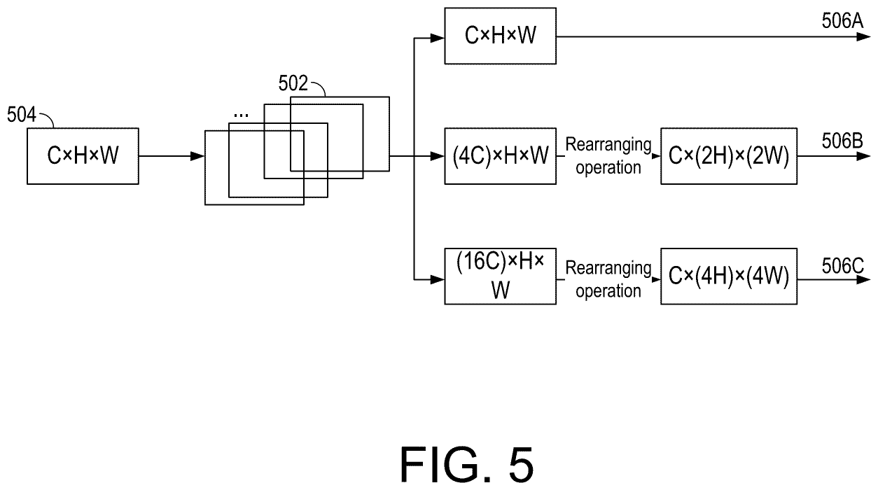

FIG. 5 illustrates a GFVC deep generative model implemented as a dynamic neural network 500 according to example embodiments of the present disclosure. Dynamic neural networks are a category of machine learning models designed with adaptive architectures that can modify their structure and operation in response to the input data during both training and inference. This form of network is effective when processing input data having variable characteristics, such as heterogeneous feature resolutions and picture resolutions.

The dynamic neural network 500 of FIG. 5 includes convolution kernels 502 of varying sizes. Though the input features 504 have a fixed resolution [h′, w′], a different convolution kernel 502 is, respectively, applied to the input features 504 depending on the original picture resolution. Regardless of picture resolution, the output (illustrated as 506A, 506B, and 506C) of the applied convolution kernel has the same resolution [h′, w′] but has more channels for larger picture resolutions: for a resolution difference of 2×, the channel size of the output 506B has a difference of 4×, and for a resolution difference of 4×, the channel size of the output 506C has a difference of 16×. A rearranging operation is further performed upon the output of the applied convolution kernel to rearrange channel data to upscale the resolution by 2× per 4× channel data rearranged (thus, the output 506B is upscaled by 2×, and the output 506C is upscaled by 4×).

FIG. 6 illustrates an example system 600 for implementing the processes and methods described above for performing GFVC upon heterogeneous-resolution sequences based on consistent resampling factors and based on adaptive resampling factors.

The techniques and mechanisms described herein may be implemented by multiple instances of the system 600 as well as by any other computing device, system, and/or environment. The system 600 shown in FIG. 6 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 600 may include one or more processors 602 and system memory 604 communicatively coupled to the processor(s) 602. The processor(s) 602 may execute one or more modules and/or processes to cause the processor(s) 602 to perform a variety of functions. In some embodiments, the processor(s) 602 may include a central processing unit (“CPU”), a graphics processing unit (“GPU”), both CPU and GPU, or other processing units or components known in the art. Additionally, each of the processor(s) 602 may possess its own local memory, which also may store program modules, program data, and/or one or more operating systems.

Depending on the exact configuration and type of the system 600, the system memory 604 may be volatile, such as RAM, non-volatile, such as ROM, flash memory, miniature hard drive, memory card, and the like, or some combination thereof. The system memory 604 may include one or more computer-executable modules 606 that are executable by the processor(s) 602.

The modules 606 may include, but are not limited to, an encoder 608, a decoder 610, a feature extractor 612, a reconstructed feature extractor 614, a dense motion model 616, a deep generative model 618, and a neural network training module 620 as described above with reference to FIGS. 2 and 3.

The encoder 608 configures the processor(s) 602 to perform picture coding by any of the techniques and processes described above, such as an image compression process 100 of FIG. 1.

The decoder 610 configures the processor(s) 602 to perform picture coding by any of the techniques and processes described above, such as an image compression process 100 of FIG. 1.

The feature extractor 612 configures the processor(s) 602 to perform picture coding by any of the techniques and processes described above, such as feature extraction as described above with reference to FIGS. 2 and 3.

The reconstructed feature extractor 614 configures the processor(s) 602 to perform picture coding by any of the techniques and processes described above, such as reconstructed feature extraction as described above with reference to FIGS. 2 and 3.

The dense motion model 616 configures the processor(s) 602 to perform picture coding by any of the techniques and processes described above, such as computing a relevant sparse motion field and yielding a pixel-wise dense motion map as described above with reference to FIGS. 2 and 3.

The deep generative model 618 configures the processor(s) 602 to perform picture coding by any of the techniques and processes described above, such as reconstructing a reconstructed subsequent picture as described above with reference to FIGS. 2 and 3.

The neural network training module 620 configures the processor(s) 602 to train any learning model as described herein, such as a feature extractor 612, a reconstructed feature extractor 614, a dense motion model 616, or a deep generative model 618.

The system 600 may additionally include an input/output (I/O) interface 640 for receiving input picture data and bitstream data, and for outputting decoded pictures to a display, an image processor, a learning model, and the like. The system 600 may also include a communication module 650 allowing the system 600 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transitory computer-readable storage media that, when executed by one or more processors, may perform operations described above with reference to FIGS. 1-5. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
extracting a compact human feature from a plurality of subsequent pictures of a sequence;
scaling the compact human feature by a resampling factor which is constant for sequences of heterogeneous resolutions;
reconstructing a base picture of the sequence and reconstructing the plurality of subsequent pictures;
extracting a reconstructed base feature from the reconstructed base picture;
scaling the reconstructed base feature by the resampling factor;
decoding a reconstructed subsequent feature from the compact human features transmitted in a bitstream; and
reconstructing a reconstructed subsequent picture by a generative face video compression (“GFVC”) model based on the reconstructed base feature and the reconstructed subsequent feature.

2. The computing system of claim 1, wherein the compact human feature comprises learned keypoints extracted by a source keypoint extractor and a driving keypoint extractor of a First Order Motion Model (“FOMM”).

3. The computing system of claim 1, wherein the compact human feature comprises a compact feature matrix extracted by a compact feature learning (“CFTE”) feature extractor.

4. The computing system of claim 1, wherein the compact human feature comprises facial semantics extracted according to Interactive Face Video Coding (“IFVC”).

5. The computing system of claim 1, wherein scaling the compact human feature and scaling the reconstructed base feature are performed by inputting the compact human feature to a feature extractor comprising a plurality of down-sampling layers which each configures one or more processors of a computing system to down-sample by a same factor.

6. The computing system of claim 1, wherein scaling the compact human feature and scaling the reconstructed base feature are performed by inputting the compact human feature to a feature extractor comprising a plurality of up-sampling layers which each configures one or more processors of a computing system to up-sample by a same factor.

7. The computing system of claim 1, wherein scaling the compact human feature further comprises interpolating the compact human feature and scaling the reconstructed base feature further comprises interpolating the reconstructed base feature.

8. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
extracting a compact human feature from a plurality of subsequent pictures of a sequence;
resampling the compact human feature to a resolution which is constant for sequences of heterogeneous resolutions;
reconstructing a base picture of the sequence and reconstructing the plurality of subsequent pictures;
extracting a reconstructed base feature from the reconstructed base picture;
resampling the reconstructed base feature to the resolution;
decoding a reconstructed subsequent feature from the compact human features transmitted in a bitstream; and
reconstructing a reconstructed subsequent picture by a generative face video compression (“GFVC”) model based on the reconstructed base feature and the reconstructed subsequent feature.

9. The computing system of claim 8, wherein the compact human feature comprises learned keypoints extracted by a source keypoint extractor and a driving keypoint extractor of a First Order Motion Model (“FOMM”).

10. The computing system of claim 8, wherein the compact human feature comprises a compact feature matrix extracted by a compact feature learning (“CFTE”) feature extractor.

11. The computing system of claim 8, wherein the compact human feature comprises facial semantics extracted according to Interactive Face Video Coding (“IFVC”).

12. The computing system of claim 8, wherein resampling the compact human feature and resampling the reconstructed base feature are performed by inputting the compact human feature to a feature extractor comprising a plurality of down-sampling layers which each configures one or more processors of a computing system to down-sample by a same factor.

13. The computing system of claim 8, wherein resampling the compact human feature and resampling the reconstructed base feature are performed by inputting the compact human feature to a feature extractor comprising a plurality of up-sampling layers which each configures one or more processors of a computing system to up-sample by a same factor.

14. The computing system of claim 8, wherein resampling the compact human feature further comprises interpolating the compact human feature and resampling the reconstructed base feature further comprises interpolating the reconstructed base feature.

15. A computing system, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
decoding a reconstructed subsequent feature from compact human features transmitted in a bitstream; and
reconstructing a reconstructed subsequent picture by a generative face video compression (“GFVC”) model based on the reconstructed base feature and a reconstructed subsequent feature, wherein the reconstructed subsequent picture has a resolution different from a resolution of the reconstructed subsequent feature.

16. The computing system of claim 15, wherein the GFVC model comprises a plurality of convolutional kernels of different sizes, and wherein a different convolutional kernel is applied for each different original picture resolution.

17. The computing system of claim 16, wherein each of the plurality of convolutional kernels configures one or more processors of a computing system to output a number of channels proportional to a square of the original picture resolution.

18. The computing system of claim 17, wherein the operations further comprise rearranging output channels to upscale the reconstructed subsequent picture.
